(19) United States
(12) Patent Application Publication
(10) Pub. No.: US 2002/0017494 A1
(43) Pub. Date: Feb. 14, 2002

(54) Potable water treament system and method of operation thereof

(76) Inventor: Richard Alan Haase, Missouri City, TX (US)

Correspondence Address: THE MATTHEWS FIRM, 1900 WEST LOOP SOUTH, SUITE 1800, HOUSTON, TX, 77027, US

(21) Appl. No.: 09/918,246

(22) Filed: Jul. 30, 2001

Related U.S. Application Data
(63) Continuation of application No. 09/298,155, filed on Apr. 23, 1999, now abandoned.

(51) Int. Cl. B01J 20/00; C02F 5/08

(52) U.S. Cl. 210/696; 210/198.1; 210/96.1

(57) ABSTRACT

In the present invention, a potable water treatment system for treating potable-water that is being transferred from a potable water source to a number of potable water using entities via a potable water line is presented. Said potable water treatment system has a chemical feed system that comprises a measuring device for measuring the characteristics of the potable water in the potable water line, a number of chemical feed sources containing a number of chemical additives (including, but not limited to, a number of chelants, a number of oxidizers and a number of dispersants), a proportioning device for determining any required amounts of the number of chemical additives to be added from the chemical feed source to the potable water in the potable water line and a number of controlling pumps for adding the required amounts of the number of chemical additives to the potable-water in the potable water line. Upon determination by the measuring device and the proportioning device of the required amounts of the number of chemical additives, the required amounts of the number of chemical additives are directed via the number of controlling pumps from the number of chemical feed sources to the potable water line at any desired position between the potable water source and the potable water using entities. The method of operation of the potable water treatment system is also presented.

### BACKGROUND OF THE INVENTION

1. Field of the Invention

The present invention relates to chemical treatment of potable water. The invention provides a potable water treatment system, and method of operation thereof, comprising a chemical feed system for administering a number of chemical additives to the potable water by using a number of controlling pumps, a measuring device and a proportioning device and adding said number of chemical additives in proportion to the quantity and/or quality of the potable water flowing from a potable water source via a potable water line to potable-water using entities.

2. Description of the Prior Art

A major issue with which potable water consumers in potable-water using entities (including, but not limited to residential, office, public and commercial buildings) have been faced is the ability to control taste, odor, turbidity and mineral deposits of potable water from potable water sources. Practically all waters contain some calcium and/or magnesium which exist in such waters in the form of soluble salts, usually sulphates, bicarbonates or chlorides, with the soluble salts being ionized so that the waters contain a relatively large concentration of free calcium and/or magnesium ions. Waters can be divided roughly into two general classes, the so-called “soft” waters and the so-called “hard” waters. There is no sharp line of division between the two, and some waters lie about midway between what would be considered to be a soft water or a hard water. In general, the soft waters contain relatively small amounts of calcium and magnesium. The extent of the decrease of the free calcium and/or magnesium ions determines the degree of softening. While the softening of waters is most commonly effective to render the waters better-suited for washing purposes, water softening is not limited to such uses, as hard waters are also softened for various other residential, office, public and commercial purposes.

Current technology for mineral and metal removal in order to soften potable water involves either using distillation plants or using lime-softening plants or using cation-exchange softeners. By distillation and condensation of the steam, pure water is evaporated from the impure hard water, the impurities remaining behind. Distillation requires a distillation apparatus and is very energy intensive and relatively expensive. Lime-softening plants are very expensive and, therefore, there are not many lime softening plants. Cation-exchange softeners used at residential units cause an increase of sodium ion content of water and a decrease in the calcium (and magnesium) ion content of water due to cation exchange between calcium and sodium (or between magnesium and sodium). “Water-softening compounds” (e.g. sodium carbonate (washing soda), trisodium phosphate which is sold under various trade names, lime soda ash (sodium phosphate) and sodium silicate) that are used for softening potable water, are highly alkaline and, thus, water softened by their use is rendered highly alkaline. Upon application of the water softening compounds, the calcium and magnesium ions in the potable water which are helpful for consumers are converted for the most part into insoluble salts which are precipitated and which may be removed. However, the free sodium ions which are not beneficial to consumers remain dissolved in the softened water. It is usually necessary for such water softening to use a large excess of the water-softening compounds with a consequence of excessive alkalinity imparted to the softened water. High alkalinity of water is objectionable for many purposes (for example, when water is used by potable water using entities) since the alkalinity attacks the human skin and the fibers of fabrics being washed. When fabrics are washed in high alkalinity or high hardness water, softening requires so much cationic exchange that the sodium content of the water leaves the water slightly salty. In many cases, reverse osmosis follows softening in order to produce calcium, sodium and cation-free water. As such, current technology is rather bulky and expensive with installed cation-exchange softeners retailing for at least $1,000 to over $5,000. Also, once the salt of the water-softening compound is spent, it must be replaced.

In addition, a number of problems in combination cause less than ideal qualities of the existing water treatment systems. Alkaline earth cations (such as calcium, magnesium, iron, copper, aluminum and silica ions) are common impurities in potable water that form deposits. The exact combinations in which the impurities exist are different from potable water stream to potable water stream and, even, location to location. Also, the deposits are usually somewhat selective for any given water chemistry. The resulting deposits usually fall into one of two types: scale deposits (being crystallized directly on inner surfaces of water lines) and sludge deposits (consisting of various salts that have precipitated elsewhere, which consist of discrete and usually non uniform particles).

Sludge and scale deposits settle at low flow points in water lines. Scale deposits are formed by precipitation of a number of different scale-forming salts, the nature of which depends on the local chemical makeup of the potable water. Compared to other precipitation reactions, the crystallization of scale deposits is a slow reaction and, thus, promotes the formation of a fairly well-defined, slow, in-place crystal growth, resulting in deposition of a hard, dense, glassy and highly insulating material. Some forms of scale deposits are so tenacious that they resist any type of removal, mechanical or chemical.

Scale deposits from hard waters will also cause potable water lines to leak, resulting in higher labor costs, equipment replacement costs and further cleaning costs. Extremely severe scale deposits can even cause rupture in water lines. Sludge deposits are formed by the accumulation of solids that have precipitated in the potable water. After deposition has started, many particles become bound to one another. Binding is often a function of surface charge. Intraparticle bonding need not occur between every particle in a deposit mass to physically bind the accumulation together. Some non-bound particles can be effectivefy captured in a network of bound particles.

Since external water treatments (such as coagulation and filtration) do not adequately and efficiently remove solids and solid-forming impurities in potable water, various chemical water treatments have been used to prevent and remove scale and sludge in potable water. Chemical water treatments generally involve a combined use of a precipitating agent (such as soda ash, i.e. sodium phosphate, which contains anions such as phosphates) and a solid conditioner to maintain the solid impurities in the potable water in a suspended state. Due to small changes in pH, pressure or temperature in the potable water or the presence of additional ions with which anions and cations form insoluble products, these anions and cations combine and precipitate, forming deposits. Corrosion of metal inner surfaces of the water lines by hardness deposits is facilitated since corrosion-control agents are unable to contact the surfaces effectively. Removal of the deposits can cause expense, delays and shutdowns of the water treatment systems.

Years ago, phosphate control was introduced to minimize wide-spread calcium carbonate scaling throughout water lines by eliminating calcium carbonate scale formation in favor of a precipitate that could produce sludge. Scale inhibitors that have been used are inorganic phosphorus compounds, such as tri-poly phosphoric acid, pyrophosphoric acid, hexametaphosphoric acid, and organic phosphorus compounds, such as alkyl phosphate and alkyl phosphite. However, inorganic polyphosphoric acids, phosphonic acids and organic phosphoric esters, when used in low concentration, adversely act to enhance corrosion and, when added in high concentrations, lead to the formation of scale. The inorganic polyphosphoric acids are hydrolized in water to produce orthophosphoric acid ions which act upon polyvalent metal ions (e.g. calcium ions) to form insoluble precipitates. Phosphonic acids and organic phosphoric acid esters are hydrolized in cool water and act upon polyvalent metal ions to form insoluble precipitates which turn into scales. Using phosphates and phosphate polymers to chelate calcium, magnesium and metals can provide a solution.

The technology of using phosphates to chelate calcium, magnesium and metals is well-known. Alkalinity is a major factor in using phosphates for chelation. If insufficient water alkalinity is maintained, magnesium can combine with phosphates, forming magnesium phosphate, a particle with a surface charge that makes it very prone to adhere to inner surfaces of water lines and then collect other solids. Therefore, it is difficult to maintain a predetermined concentration of polyvalent metal ions in alkaline water, where calcium hardness co-exists and the pH is high, and the polyvalent metal ions precipitate as hydroxides, phosphates and phosphoric acids, to name a few. Municipalities have been adding a variety of phosphates and phosphate polymers to potable water sources for decades to control mineral and metal deposition. However, the goals of municipalities and the goals of potable-water using entities are rather discongurent. Municipalities add phosphates and phosphate polymers to control corrosion in metal pipes of water lines and to control consumer complaints from mineral deposition staining on clothing and plumbing fixtures. In recent years, some municipalities have begun to install concrete and plastic pipes for water lines and, thus, no longer add any phosphate polymers to the potable water. Even if municipalities would provide enough phosphates to treat potable water of a temperature of 140° F., municipalities do not add any chelating or dispersing polymers to prevent calcium phosphate build-up in hot water lines. In addition, phosphates have required dosage limits in potable water. NSF International analyzes the toxicity of phosphates, placing a dosage limit on their application in potable water.

Therefore, the addition of phosphates to potable water must be regulated and proportioned to the water flow rate.

As a result, the potable-water using entities must pay additional laundry expenses since the calcium and magnesium mineral deposits reduce the effectiveness of laundry detergents. The potable water using entities must pay extra to control and clean mineral deposits of pools, plumbing fixtures, bathroom fixtures, bathroom tiles and bathroom glass. Most importantly, the potable-water using entities must pay extra to clean and , replace hot water heaters due to scale build-up in hot water heaters from calcium and magnesium mineral scale deposits. Mineral scale deposition is increased by temperature and, as a result, maximal mineral scale deposits and maximal maintenance expenses are in hot water lines. There is, therefore, a distinctly difficult problem presented by the necessity of maintaining an alkaline condition in the potable water while limiting concentration of alkalinity in the potable water to that compatible with safe or desirable operating conditions and, at the same time, continuously maintaining in the water a sufficient concentration of a radical such as phosphate for chelating calcium and/or magnesium ions. Such phenomena vary depending on the water temperature and become greater when the calcium hardness increases and the pH rises. Therefore, it is necessary to determine the required amounts of chemical additives depending on the water temperature, pH and hardness.

In the prior art, devices and systems that have been used to treat potable water at low pressures usually resort to first passing the potable water into a reservoir and then dripping chemical additives into the reservoir with a pump. Methods of application of such systems and devices can be relatively complex and costly and require very careful control. The present invention does not require passing of the potable water into a reservoir. In the present invention, the potable water is treated without using any complicated equipment. In a preferred embodiment, the number of chemical additives, that serve to chelate calcium and magnesium ions, are simply added to the potable water by using a measuring device, a proportioning device and a controlling pump. Thus, the potable water treatment system is preferred particularly for the potable water using entities. The potable water using entities can obtain a completely-chelated crystal-clear potable water in which the calcium and magnesium ions are maximized due to their chelation and in which the alkalinity is not increased, so that it can be used without damage to the skin, to fabrics or to human health.

Several related patents that have been issued in the past decades are:

In U.S. Pat. No. 1,903,041, issued to Hall et al. on Mar. 28, 1933, a water treatment process in a steam boiler is described, wherein a chemical containing a molecularly dehydrated phosphate radical is supplied to the boiler water and is then re-hydrated in the water to a condition of greater alkali-neutralizing capacity.

In U.S. Pat. No. 19,719, reissued on Oct. 8, 1935, to Hall et al., a process of softening water containing an alkaline-earth metal compound is presented. The process comprises adding an alkali-metal meta phosphate which is water soluble and capable of sequestering calcium in a but slightly ionized condition in an amount sufficient to effectively suppress the soap-consuming alkaline-earth metal ion concentration. In U.S. Pat. No. 2,142,5, issued to Joos on Jan. 3, 1939, a water softening method which comprises treating water in a reaction zone with lime and soda to reduce the hardness of the water is presented. In a second reaction zone, the water is treated with tri-sodium phosphate and sodium hydroxide in proportions to provide in the treated water an excess of tri-sodium phosphates. In U.S. Pat. No. 2,304,850, issued to Rice on December, 1942, a process of presenting precipitation of dissolved ion in well water is presented. The process comprises adding to the water in the well, before it is exposed to air, molecularly dehydrated alkali-metal phosphate in amounts of about 1 to parts by weight per part of ion. In U.S. Pat. No. 2,596,943, issued to Sheen on May 13, 1952, a proportional feed system is presented. The proportional feed system is an electric proportioning pump for supplying liquid to a system in response to electric circuit operation by flow in the system and comprises a solenoid adapted to be energized at intervals by the electric circuit operation, a positive displacement pump operatively connected to the solenoid, a shock absorber operatively connected to the pump and controlling the extent and speed of operation of the pump and an adjustable stop in the shock absorber for limiting the length of stroke of the pump.

In U.S. Pat. No. 2,874,719, issued to Van Tuyl on Feb. 24, 1959, a device for feeding additive into a moving liquid is presented. The device comprises a housing having an additive supply source, a first bore and a second bore being spaced from each other, an additive inlet channel leading from the additive supply source to the first bore, an additive outlet channel leading from the first bore to the second bore, with said additive outlet channel being offset laterally from said additive inlet channel, means in the second bore restricting the flow of liquid in the second bore, and, disposed between said additive inlet channel and said additive outlet channel, a valve assembly incorporating a check valve responsive to the flow of liquid in the second bore and a manually adjustable needle valve for controlling the rate of flow of the additive through said additive outlet channel into the second bore, one of the valves being disposed within the other.

In U.S. Pat. No. 4,9,398, issued to Ii et al. on Jun. 24, 1980, a process for treating water to inhibit formation of scale and deposits on surfaces in contact with water and to minimize corrosion of the surfaces is presented. The process comprises mixing in the water an effective amount of waters-soluble polymer containing a structural unit that is derived from a monomer having an ethylenically unsaturated bond and having one or more carboxyl radicals, at least a part of said carboxyl radicals being modified, and one or more corrosion inhibitor compounds selected from the group consisting of inorganic phosphoric acids and water-soluble salts thereof, phosphonic acids and water-soluble salts thereof, organic phosphoric acid esters and water-soluble salts thereof and polyvalent metal salts, capable of being dissociated to polyvalent metal ions in water. In U.S. Pat. No. 4,442,009, issued to O'Leary et al. on Apr. 10, 1984, a method for controlling scale formed from water-soluble calcium, magnesium and iron impurities contained in boiler water is presented. The method comprises adding to the water a chelant and water-soluble salts thereof, a water soluble phosphate salt and a water soluble poly methacrylic acid or water soluble salts thereof. In U.S. Pat. No. 4,631,131, issued to Cuisia et al. on Dec. 23, 1986, a method for inhibiting formation of scale in an aqueous steam generating boiler system is presented. Said method comprises a chemical treatment consisting essentially of adding to the water in the boiler system scale-inhibiting amounts of a composition comprising a copolymer of maleic acid and allyl sulfonic acid or a water soluble salt thereof, hydroxy ethylidenel, 1 diphosphonic acid or a water-soluble salt thereof and a water-soluble sodium phosphate hardness precipitating agent.

In U.S. Pat. No. 5,4,264, issued to Armstrong on Oct. 19, 1993, a method of dispensing scaling inhibitors into a flow of low-pressure water by modifying the use of available air lubricators is presented. In U.S. Pat. No. 5,419,836, issued to Ray et al. on May 30, 1995, a method for dispensing a plurality of additives into untreated ground water contained in a poultry watering system is presented. The method comprises supplying untreated ground water to a poultry watering system, circulating the water, fluidly connecting a plurality of feed containers containing the plurality of additives to the water, the additives including a scale inhibitor and an oxidant, proportionately dispensing, in relationship to flow, the plurality of treatment additives using hydraulically operated pumps and filtering unwanted matter from the water. These registered patents do not take into account a system for treating municipal potable water that is available for use by potable-water using entities, while controlling turbidity, removing organics, controlling taste and odor, controlling mineral deposits, controlling potability and minimizing expenses of treatment of the potable water.

### SUMMARY OF THE INVENTION

A primary object ofthe invention is to devise a potable water treatment system for chelating, while improving potability of, potable water leaving potable water sources.

Another object of the invention is to devise a potable water treatment system for controlling scale build-up in potable hot water systems while improving potability of potable water leaving potable water sources.

An additional object of the invention is to devise a potable water treatment system for controlling quality of potable water leaving potable water sources without using bulky and expensive softening equipment. Yet another object of the invention is to provide a potable water treatment system for controlling mineral deposits from, while improving potability of, potable water leaving potable water sources.

An additional object of the invention is to devise a potable water treatment system for controlling taste and odor in, while improving potability of, potable water leaving potable water sources. Another object of the invention is to devise a potable water treatment system for removing organics from, while improving potability of, potable water.

Still another object of the invention is to devise a potable water treatment system for controlling turbidity of, while improving potability of, potable water.

A final object of the invention is to provide a potable water treatment system for quality control of, while improving potability of, potable water leaving potable water sources that is relatively inexpensive as compared to other methods and systems that are currently being employed.

Additional objects and advantages of the invention will be set forth in part in a detailed description which follows, and in part will be obvious from the description or may be learned by practice of the invention. The present invention provides a potable water treatment system for treating potable water and method of operating the potable water treatment system upon administering a number of chemical additives to a potable water line. The potable water treatment system includes a measuring device for measuring characteristics of the potable water, a proportioning device for determining the number of chemical additives and the amount thereof that are needed, and a number of controlling pumps for adding any required amounts of the number of chemical additives to the potable water line. If necessary, the addition of the number of chemical additives is followed by filtration to remove particulate matter, control taste, control odor, control turbidity, eliminate potential biological contamination or any combinations thereof. It is to be understood that the descriptions of this invention are exemplary and explanatory, but are not restrictive, of the invention. Other objects and advantages of this invention will become apparent from the following specification and from any accompanying charts, tables, examples and drawings.

### BRIEF DESCRIPTION OF CHARTS, TABLES, EXAMPLES AND DRAWINGS

Any accompanying charts, tables, examples and drawings which are incorporated in and constitute a part of this specification, illustrate examples of preferred embodiments of the invention and, along with the description, serve to explain the principles of the invention.

FIG. 1 is a flow chart demonstrating a potable water treatment system, a number of preferred embodiments of which are described below.

### DETAILED DESCRIPTION OF PREFERRED EMBODIMENTS

The present invention is described in connection with numerous preferred embodiments. However, it should be understood that the invention is not limited to those embodiments. In contrast, the invention includes all alternatives, modifications and equivalents as may be included within the spirit and scope of the specification and of the appended claims.

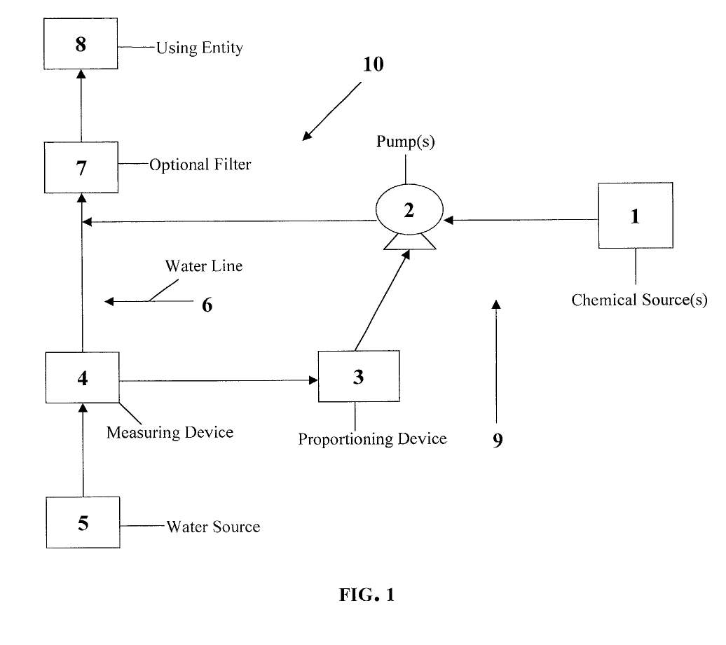

The present invention provides a potable water treatment system 10 and method of operating the potable water treatment system 10 upon administering a number of chemical additives (including, as effective components, a number of chelants, a number of dispersants and a number of oxidizers) into a potable water line 6 (consisting of potable water pipes, tubing members or the like) transferring potable water from a potable-water source (including, but not limited to a surface water treatment system, a spring or a well) to a number of potable water using entities 8. The potable water treatment system 10 includes a chemical feed system 9 that comprises a measuring device 4 (e.g. a meter) to measure quantity and quality of the potable water in the potable water line 6, a proportioning device 3 for determining any required amounts of the number of chemical additives to be added from a number of chemical feed sources 1 to the potable water in the potable water line 6 and a number of controlling pumps 2 for adding the required amounts of the number of chemical additives to the potable water in the potable water line 6. Optionally, a number of filters 7 in the potable water line 6 filter the potable water after the number of chemical additives have been added to the potable water. Although the potable water treatment system 10 may have various embodiments, several preferred embodiments of the chemical feed system 9 and their method of operation are described below. A preferred embodiment is schematically illustrated in the attached figure (FIG. 1). As shown in FIG. 1, the potable water source 5 supplies the potable water for the potable water treatment system 10 via the potable water line 6 extending from the potable water source 5 to the number of potable-water using entities 8. The measuring device 4 is connected, either directly or indirectly, to the potable water line 6 headed from the potable water source 5 towards the number of potable water using entities 8. The measuring device 4 operates along with the proportioning device 3 to determine the required amounts of any number of chemical additives that are needed for treating the potable water in the corresponding potable water line 6. The proportioning device 3, the measuring device 4 and the number of controlling pumps 2 may be separate units or may be combined with each other as a single unit (e.g. the measuring device 4 and the proportioning device 3, the measuring device 4 and the number of controlling pumps 2, the proportioning device 3 and the number of controlling pumps 2 or all three). Upon provision of measurements by the measuring device 4, the proportioning device 3 adjusts the operation of the number of controlling pumps 2 in order to control the amount of the number of chemical additives to be added to the potable water line 6. The number of controlling pumps 2 are connected, either directly or indirectly, to the potable-water line 6 of any length, but preferably in proximity to the number of potable water using entities 8. There is no circulation of the potable water from the potable water line 6 through the chemical feed system 9. In contrast, the chemical feed system 9 adds the number of chemical additives to the potable water line 6 directly. It is in the potable water line 6 that the number of chemical additives come into contact with the potable water that is heading to the number of potable-water using entities 8. In previous related patents, the potable water from the potable-water source 5 is circulated through at least one additional water treating system, thus increasing the expenses and complicating the earlier water treating systems. In the present invention, the potable water in the potable water line 6 does not exit the potable water line 6 and heads directly towards the number of potable water using entities 8. The number of controlling pumps 2 in the present invention serve to pump the required amounts of the number of chemical additives from the number of chemical feed sources 1 into the potable water in the potable water line 6. The number of chemical feed sources 1 may consist of one or more sections in which the number of chemical additives are separately or combinedly contained and which are controlled, either directly or indirectly, by the corresponding number of controlling pumps 2. The number of controlling pumps 2 provide the means to add required amounts of the number of chemical additives at various dosages to any amounts of potable waters of widely varying characteristics (including, but not limited to, chemical content, flow rate, temperature, calcium hardness, alkalinity, pH, metal content, organic content, odiferous content or any combinations thereof). As a result, the potable water treatment system 10 of the present invention is far more accurate, more efficient and less expensive than earlier water treatment systems. In addition, the present potable water treatment system operates independently of the potable water source 5 and, thus, the chemical feed system 9 may be connected to any desired portion of the potable water line 6 heading from the potable water source 5 to the potable-water using entities 8.

Therefore, in the potable water treatment system 10, the number of chemical additives may be mixed with each other and/or with the potable water without using a mixing chamber. No matter how the number of chemical additives are combined together, at least one measuring device 4 is needed to determine the quantity and quality of the potable water and at least one proportioning device 3 is needed to proportionally add any required amounts of the number of chemical additives via the number of controlling pumps 2 to the potable water line 6. In a preferred embodiment, one controlling pump 2 draws the number of chemical additives from one chemical feed source 1. In another embodiment, each chemical additive may be stored in a separate chemical feed source 1 and one controlling pump 2 may be used individually for each corresponding chemical feed source 1. In yet another embodiment, different chemical additives may be pumped from separate chemical feed sources 1 or proportionally added, as required by the measuring device 4, into one combined chemical feed source 1 from which the required amounts of the chemical additives are added by one controlling pump 2 to the potable water line 6. In addition, the number of controlling pumps 2 may be each assigned to a number of chemical feed sources 1. However, any number of controlling pumps 2 may be used along with any number of chemical feed sources 1, that consist of one or more sections in which the number of chemical additives are separately or combinedly contained and that are controlled (either directly or indirectly) by the corresponding number of controlling pumps 2, to transfer any number of chemical additives in any desired combinations from the number of chemical feed sources 1 to the potable water line 6. Although it may not be economical, an additional number of proportioning devices 3 and an additional number of measuring devices 4 may be used as well.

Although the potable water treatment system 10 may include any number of filters 7, preferably one filter 7 is positioned in the potable water line 6 immediately after any location where the number of chemical additives are added by the number of controlling pumps 2 to the potable water line 6. In the potable water line 6, the potable water that has been treated by the number of chemical additives is then filtered by the number of filters 7. At least olle filter 7 is generally, though not necessarily, used. The number of filters 7 serve to remove particulate matter, control taste, control odor, control turbidity, eliminate potential biological contamination or any combinations thereof. The filtered potable water then flows to the number of potable water using entities 8. The number of filters 7 may be of any character suitable for the purposes of the present invention. The number of filters 7 for controlling taste, controlling odor, controlling organic content, controlling turbidity (measured in NTU, i.e., Number of Turbidity Units), removing particulate matter and eliminating potential biological contamination can be, but are not limited to, granular activated carbon, anthracite, zeolite and clays. Certain phosphates and phosphate blends can precipitate metals (such as molybdenum) which can then be removed by the number of filters 7. In such cases, the number of filters 7 would be a health asset to any number of potable water using entities 8.

The measuring device 4 can be of any measuring technology or design as long as 30 the number of chemical additives are added in required amounts to the potable water line 6 by using the proportioning device 3. However, the measuring device 4 must be capable of communicating with the proportioning device 3 or directly with the number of controlling pumps 2. The measuring device 4 may also serve as the proportioning device 3, communicating directly with the number of controlling pumps 2 that can be proportioned.

The measuring device 4 is preferably, but not limited to, differential pressure, ultrasonic, magnetic or any other type that is capable of measuring quantity, quality or both of the potable water. The proportioning device 3 can be of any control logic technology as long as the proportioning device 3 is able to communicate with, or also serve as, the measuring device 4 and control the number of controlling pumps 2 that can be proportioned. The number of controlling pumps 2 can be of any liquid or solid transport technology as long as the number of controlling pumps 2 can be proportioned directly by the measuring device 4 or by the proportioning device 3. The number of controlling pumps 2 are preferably piston, peristaltic or gear. The number of controlling pumps 2 must fail in the off or closed flow position in case of a loss or surge in electrical power . The potable water treatment system 10 has a relatively simple construction which can be disassembled readily for inspection, cleaning and/or replacement of components. The chemical feed system 9 of the potable water treatment system 10 provides a novel combination of the number of controlling pumps 2, the measuring device 4 and the proportioning device 3. In addition, the chemical feed system 9 is compact and can be readily assembled with the potable water line 6. The components of the chemical feed system 9 may either be as separate units or may be combined in different forms with one another. If the chemical feed system 9 is formed of separate units, a correct assembly of the units is required to insure accuracy. However, if the components of the chemical feed system 9 are combined together, the resulting chemical feed system 9 may be more compact, more economical to manufacture and to maintain and simpler to operate. Whatever the combination may be, the major goals of the present invention shall be satisfied. The required amounts of the number of chemical additives shall be administered by the number of controlling pumps 2 to the potable water in the potable water line 6. The required amounts of the number of chemical additives shall be accurately adjustable to the quantity of and quality of the potable water. The number of chemical additives may be added, in any state (whether solid, liquid or solution) separately or combinedly, and continuously or intermittently, into the potable water. By using the measuring device 4 and the proportioning device 3, the amounts of the number of chemical additives can be adjusted according to the quantity and the quality of the potable water, such that sufficient amounts of the number of chemical additives are pumped at any point in the potable-water line 6 to the potable water.

The potable water treatment system 10 enables the number of potable-water using entities 8 to control alkalinity, control pH, control taste, control odor, remove metals, minimize deposits, remove unwanted components, control organic content, inhibit corrosion, maintain desirable components or any combinations thereof of the potable water from the potable water source 5 by providing the required amounts of the number of chemical additives to the potable water line 6. The number of oxidizers can be used to control taste, control odor, control organic content, remove metals or any combinations thereof of the potable water. The number of oxidizers increase positive charges in the potable water by removing electrons. The number of oxidizers can be, but are not limited to, potassium permanganate, bleach, aqueous ozone, hydroxides, chlorine dioxides, muriatic acids and other similar chemical oxidizers or any combinations thereof.

Chelants can be used to complex and prevent the deposition of many cations, including hardness and heavy metals. Chelants or chelating agents are compounds having a heterocyclic ring wherein at least two kinds of atoms are joined in a ring. Chelating is forming a heterocyclic ring compound by joining a chelating agent to a metal ion. Chelants contain a metal ion attached by coordinate bonds (i.e., a covalent chemical bond produced when an atom shares a pair of electrons with an atom lacking such a pair) to at least two nonmetal ions in the same heterocyclic ring. Examples of the number of chelants used for mineral deposition in the present potable water treatment system 10 are water soluble phosphates consisting of phosphate polymers, phosphate monomers or any combinations thereof. The phosphate polymers consist of, but are not limited to, phosphoric acids, phosphoric acid esters, phosphoric acids, metaphosphates, hexametaphosphates or any combinations thereof. Phosphate polymers are particularly effective in dispersing magnesium silicate, magnesium hydroxide and calcium phosphates. With a proper selection of polymers, along with maintaining adequate polymer levels, the surface charge on particles can be favorably altered. In addition to changing the surface charge, polymers also function by distorting crystal growth. Chelants lock the metals in the potable water into soluble organic ring structures of the chelants. Chelants are hydrolized in potable water and an organic anion is produced upon hydrolysis. The anionic chelants provide reactive sites that attract coordination sites (i.e. areas of the ion that are receptive to chemical bonding) of the cations. Iron, for example, has six coordination sites. All coordination sites of the iron ion are used to form a stable metal chelant. Chelants combine with cations such as calcium, magnesium, iron and copper that could otherwise form deposits. The resulting chelants are water soluble and, as long as the chelants are stable, precipitation does not occur. The effectiveness of chelants is limited by the concentration of the competing anions.

In the present invention, the concentration of the anions is either analyzed externally or is measured by the measuring device 4 first in order to proportionately add sufficient amounts of the number of chemical additives by the number of controlling pumps 2 to the potable water line 6. No rate controlling chemical additive is needed. The effect of adding sufficient amounts of the number of chelants by the present invention is to reduce the available free calcium and magnesium ions in the potable water and, therefore, to reduce the phosphate demands. In the preferred embodiments, meta phosphates and hexametaphosphates are used as chelants to prevent correspondingly any precipitation of calcium and magnesium. Sodium metaphosphate and sodium hexametaphosphate soften the potable water by removing the free calcium and magnesium ions from the potable water and by bringing the calcium and magnesium ions into a soluble slightly-ionized compound or radical, thus preserving calcium and magnesium ions (which are beneficial to humans) and deleting any hardness of the potable water that is due to free calcium and magnesium ions. The addition of meta phosphates and hexametaphosphates not only completely softens the potable water against soap so as to completely prevent the formation of insoluble calcium and magnesium soaps (which may be carried with clothes during laundering), but also effects this softening without the formation of any solid precipitates of calcium and magnesium and without rendering the potable water alkaline. In addition, the potable water containing any excess metaphosphates and hexametaphosphates will actually dissolve any phosphate or carbonate which may be deposited in the potable water line 6. Sodium metaphosphate and sodium hexametaphosphate do not throw the calcium and magnesium out of solutions as is the case of usual water-softening compounds, but rather lock up the calcium and the magnesium in a soluble sodium-calcium-metaphosphate and sodium-magnesium-hexametaphosphate complex molecule.

In addition, to control calcium phosphate build-up in potable water treatment systems 10 and obtain clean water side surfaces, the number of chelants may be added with the number of dispersants (e.g. suspension polymers). In a preferred embodiment, acids, low molecular weight anionic polymers or any combinations thereof are used as dispersants. Preferably, the number of dispersants consist of acrylic polymers. Acrylic polymers include, but are not limited to, polymers of acrylic acid, methacrylic acid, maleic acid, fumaric acid, itaconic acid, crotonic acid, cinnamic acid, vinyl benzoic acid, or any combinations thereof. Acrylic polymers exhibit a superior effect as water treating chemical additives and, when added into potable water, can prevent scale formation. Acrylic polymers exhibit a superior effect in preventing the deposition of water-soluble salts (e.g. water-soluble salts of inorganic phosphoric acids, phosphoric acids and organic phosphoric acid esters and polyvalent metal salts of alkali metal, ammonium and amine and other similar salts) and dispersing suspended particles, especially in preventing the formation of phosphatic scales. The number of dispersants should be added in an amount sufficient to disperse any particles formed by chelation in the potable water line 6. Chemical addition must be controlled since overdosing of any chemical additives can render the treated water non-potable. In order to keep the ratio of dosage of such water softening compounds relatively small, fine control of the flow of the water softening compounds is necessary.

In addition to mineral deposition, a relatively large percentage of the number of potable water using entities 8 have potable water that has taste and odor issues. These issues can usually be handled by activated carbon, oxidation or a combination of activated carbon and oxidation. Therefore, taste and odor issues can usually be handled by chemical treatment with an oxidizer and filtration. Taste and odor issues are directly attributed to organics or sulfides in the potable water from the potable water sources 5. The potable water sources 5 are under increasing pressure from the EP A and state agencies to remove more organic species. Due to the size of the potable water sources 5, a complete removal of organic compounds is not technically practical with the current available technology.

In addition to mineral deposition and taste and odor issues, the potable water provided by the potable water source 5 for many potable-water using entities 8 has a final turbidity of at least 0.1 NTU, with a final turbidity of below 0.1 NTU being required for the potable water to be free of bacterial organisms called cryptosporidium. Cryptosporidium are the bacteria that made thousands sick in Minneapolis causing the EPA to re-evaluate potable water quality standards. It is estimated that between 60,000 and 1,500,000 individuals in the United States become ill every year due to exposure to cryptosporidium. Cryptosporidium is common in water supplies and can infect consumers even when present at very low levels in the water. Cryptosporidium has been found in 97% of surface water supplies and 39% of potable water supplies. Once an individual is infected, an incubation period of 2 to 12 days and an illness period of 14 days, and even up to six months, follow. In individuals with weakened immune systems, the cryptosporidium can be fatal. The best solution for removing cryptosporidium from potable water is to remove particulate matter by turbidity monitoring, with a goal of turbidity of less than 0.1 NTU. The present potable water treatment system is the only presently available solution for removing cryptosporidium from the potable water, except for at point-of-use water filtration system and for boiling of water. In the present potable water treatment system, filtration through a number of granular activated carbon filters 7 will eliminate potential biological contamination of the potable water.

By adding the number of chemical additives into the potable water line 6 after the potable water has been treated by the potable water source 5, scale formation and contamination of the inner surfaces of the potable water line 6 are decreased. In particular, prevention of scale formation and of contamination are of greater significance on the inner metal surfaces which are in contact with the potable water.

In order to prevent corrosion, scale formation and contamination, the phosphoric compounds are added to the potable water in the potable water line 6 in combination with conventional corrosion inhibitors for iron, steel, copper, copper alloys or other metals, conventional scale and contamination inhibitors, metal sequestering agents and other conventional water-treating agents. Such improvements are due to the fact that the added polymers strongly prevent the phosphoric compounds and polyvalent metals from becoming insoluble compounds and precipitating. Such effect can be maintained in the potable water treatment system 10 even when the hardness and small pH of the potable water are high, since the amount of the number of chemical additives is adjusted by the number of controlling pumps 2 and by the measuring device 4 to be sufficient for any quality and quantity of potable water. Neither the temperature, nor the quantity, nor the quality, nor the concentration of chemicals in the potable water affect the final quality of the potable water used by the potable water using entities 8. In a preferred embodiment, a slight alkalinity in the potable water making contact with the potable water line 6 best prevents corrosion. The pH value of a sample drawn from any point in the potable water line 6 downstream of the potable water treatment system 10 should be in no case less than 7. Use of phosphates in the potable water is effective in decreasing the total alkalinity of the potable water, but has little affect on the maintenance of desired pH values in the potable water. By adding acrylic acid to the potable water, deposition of scale and sludge can be controlled, and, by adding an alkaline chemical such as trisodium phosphate, the desired pH value in the potable water is maintained. As a summary, the advantages of the present potable water treatment system 10 are:

(1) Elimination or minimization of deposits in the potable water lines 6; and

(2) Maintenance of desirable pH values in the potable water to prevent corrosion without accumulation of alkalinity beyond desirable proportions in the potable water lines 6;

(3) Elimination of costly methods of feeding the number of chemical additives 5 to the potable water lines 6; and

(4) Accuracy of control of the amounts of any number of chemical additives forwarded to the potable water lines 6.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

I claim:

1. A potable water treatment system for treating potable water that is being transferred from a potable water source to a number of potable-water using entities via a potable water line, said potable water treatment system comprising:
(a) a chemical feed system that comprises:
(i) a measuring device for measuring characteristics of the potable water in the potable water line,
(ii) a number of chemical feed sources containing a number of chemical additives,
(iii) a proportioning device for determining any required amounts of the number of chemical additives to be added from the number of chemical feed sources to the potable water in the potable water line, and
(iv) a number of controlling pumps for adding the required amounts of the number of chemical additives to the potable water in the potable water line; such that, upon determination by the measuring device and the proportioning device of the required amounts of the number of chemical additives, the required amounts of the number of chemical additives are directed via the number of controlling pumps from the number of chemical feed sources to any desired location of the potable water line.

2. The potable water treatment system of claim 1 wherein the measuring device, the proportioning device and the number of controlling pumps are separate units or are combined with each other as a single unit, the proportioning device and the number of controlling pumps are combined with each other as a single unit, the measuring device and the number of controlling pumps are combined with each other as a single unit or the measuring device and the proportioning device are combined with each other as a single unit.

3. The potable water treatment system of claim I wherein a number of filters are used in the potable water line, such that the number of filters filter the potable water after the number of chemical additives are added to the potable water and such that the number of filters serve to remove particulate matter, control taste, control odor, control organic content, control turbidity, eliminate potential biological contamination or any combinations thereof of the potable water.

4. The potable water treatment system of claim 3 wherein the number of filters 5 consist of granulated activated carbon, anthracite, zeolite and clays.

5. The potable water treatment system of claim 1 wherein the measuring device is differential pressure, ultrasonic, magnetic or any other type that is capable of measuring quantity, quality or both of the potable water.

6. The potable water treatment system of claim 1 wherein the number of controlling pumps are piston, peristaltic or gear.

7. The potable water treatment system of claim 1 wherein the number of chemical additives are added separately or combinedly, continuously or intermittently and in any state to the potable water, such states consisting of solid, liquid, solution or any combinations thereof solution.

8. The potable water treatment system of claim 1 wherein effective components of the number of chemical additives consist of any required amounts of a number of chelants, any required amounts of a number of dispersants, any required amounts of a number of oxidizers, any required amounts of a number of corrosion inhibitors or any combinations thereof.

9. The potable water treatment system of claim 1 wherein the required amounts of the number of chemical additives are determined by measuring quantity, rate of flow, temperature, pH, chemical content, alkalinity, metal content, organic content, odiferous content, calcium hardness or any combinations thereof of the potable water.

10. The potable water treatment system of claim 9 wherein the alkalinity of the potable water is maintained such that the pH of the potable water in the potable water line is not less than 7.

11. The potable water treatment system of claim I wherein the number of chemical feed sources consist of one or more sections in which the number of chemical additives are separately or combinedly contained and are controlled, either directly or indirectly, by the corresponding number of controlling pumps.

12. The potable water treatment system of claim 8 wherein the number of oxidizers are chemicals that consist of potassium permanganate, bleach, aqueous ozone, hydroxides, chlorine dioxides, muriatic acids, other similar chemical oxidizers or any combinations thereof and are used to control taste, control odor, remove organics, remove metals or any combinations thereof from the potable water.

13. The potable water treatment system of claim 8 wherein the number of chelants consist of water soluble phosphates.

14. The potable water treatment system of claim 13 wherein the water soluble phosphates consist of phosphate polymers, phosphate monomers, phosphoric acids or any combinations thereof.

15. The potable water treatment system of claim 14 wherein the phosphate polymers consist of phosphoric acid esters, phosphoric acids, metaphosphates, hexametaphosphates or any combinations thereof.

16. The potable water treatment system of claim 8 wherein the number of dispersants consist of acids, low molecular weight anionic polymers or any combinations thereof.

17. The potable water treatment system of claim 16 wherein the low molecular weight anionic polymers consist of acrylic polymers.

18. The potable water treatment system of claim 17 wherein the acrylic polymers consist of polymers of acrylic acid, methacrylic acid, maleic acid, fumaric acid, itaconic acid, crotonic acid, cinnamic acid, vinyl benzoic acid or any combinations thereof.

19. The method of operation of a potable water treatment system for treating/potable water that is being transferred from a potable water source to a number of potable water using entities via a potable water line, said potable water treatment system comprising:
(a) a chemical feed system that comprises:
(i) a measuring device for measuring characteristics of the: potable water in the potable water line,
(ii) a number of chemical feed sources containing a number of chemical additives,
(iii) a proportioning device for determining any required amounts of the number of chemical additives to be added from the number of chemical feed sources to the potable water in the potable water line, and
(iv) a number of controlling pumps for adding the required amounts of the number of chemical additives to the potable water in the potable water line; said method comprising:
(a) determining, by using the measuring device and the proportioning device, the required amounts of the number of chemical additives to be added to the potable water in the potable water line; and
(b) forwarding, by using the number of controlling pumps, the required amounts of the number of chemical additives from the number of chemical feed sources to the potable water line;
such that the required amounts of the number of chemical additives react with the potable water to minimize deposits, to maintain any desirable components dissolved in the potable water, to remove any unwanted components of the potable water, to control corrosion or any combinations thereof.

20. The method of claim 19, wherein a number of filters are used in the potable water line, such that, after the number of chemical additives are added to the potable water, the number of filters filter the potable water to control taste, control odor, control turbidity, eliminate potential biological contamination, control organic content, remove particulate matter or any combinations thereof of the potable water.

21. The method of claim 19 wherein the number of chemical additives are added in any state, consisting of solid, liquid, solution or any combinations thereof, separately or combinedly, and continuously or intermittently.

22. The method of claim 19 wherein effective components of the number of chemical additives that are added to the potable water consist of any required amounts of a number of chelants, any required amounts of a number of dispersants, any required amounts of a number of oxidizers, any required amounts of a number of corrosion inhibitors or any combinations thereof.

23. The method of claim 19, wherein the required amounts of the number of chemical additives are determined by measuring quantity, rate of flow, temperature, pH, chemical content, alkalinity, calcium hardness, metal content, organic content, odiferous content or any combinations thereof of the potable water.

24. The method of claim 23 wherein the alkalinity of the potable water is maintained such that the pH of the potable water in the potable water line is not less than 7.

25. The method of claim 23 wherein the number of chelants consist of water soluble phosphates which are added to decrease the alkalinity of the potable water or to inhibit corrosion or both.

26. The method of claim 22 wherein the number of dispersants are added to the potable water to control deposition of scale and sludge.

27. The method of claim 22 wherein the number of oxidizers are added to control taste, control odor, control organic content, remove metals of the potable water or any combinations thereof.

28. The method of claim 19 wherein the number of controlling pumps fail in an off or closed position if there is a loss or surge in electrical power.
